(19) United States
(12) Patent Application Publication
(10) Pub. No.: US 2009/0201678 A1
(43) Pub. Date: Aug. 13, 2009

(54) HEAT SINK FOR SEMICONDUCTOR LIGHT SOURCES

(76) Inventor: Jay F. Raley, San Jose, CA (US)

Correspondence Address: SCHNECK & SCHNECK, P.O. BOX 2-E, SAN JOSE, CA, 95109-0005, US

(21) Appl. No.: 12/028,688

(22) Filed: Feb. 8, 2008

(51) Int. Cl. F21V 29/00

(52) U.S. Cl. 362/235

(57) ABSTRACT

A packaging structure for an array of semiconductor light sources that provides a heat sink using conduction, convection and radiation of heat. The array, mounted on a base, transfers heat by conduction to a first metal surface slightly spaced apart from a second metal surface. A liquid transfers heat by convection from the first metal surface to the second thereby spreading the heat over both the first and second metal surfaces which can radiate heat to the ambient environment. Where the metal surfaces are cup-shaped, the metal surfaces can form a beam if the light sources are placed near a focal area of a parabolic cup-shaped reflector surface. Optional screw threads allow use in conventional sockets and may house an optional transformer and rectifier.

### TECHNICAL FIELD

The invention relates to a packaging structure for semiconductor light sources that performs heat sink functions.

### BACKGROUND ART

In the past few years high power semiconductor light sources, such as light emitting diodes, known as LEDs, and diode lasers, have been used in increasing number of applications, including automotive, signaling, and decorative illumination applications. A problem that is encountered relates to packaging high power semiconductor light sources in compact configurations. Such sources require significant amounts of energy, giving rise to localized heating that places limits on compactness. In response, coolant structures have been developed that provide for thermal management.

U.S. Pat. No. 7,285,445 to M. Owen et al. discloses a coolant flow system for an LED array. A gas or liquid fluid is forced to flow past the LED array for heat exchange, then heat is remotely removed from the fluid. Special flow channels may be provided to direct a fluid, such as air, past the LED array under pressure from a fan so that the air can dissipate heat to the ambient environment. Use of heat pipes and an air-cooled radiator is suggested as a remote heat exchanger.

U.S. Pat. No. 5,751,327 to DeCock et al. discloses an LED array as part of a printer head. A carrier bar for the array has a U-shaped duct inside a thermally conductive housing for the array in contact with the head. The duct carries coolant, such as water, through the duct to remove heat from the housing. The coolant is remotely cooled.

The abstract of Chinese patent CN 1828956 indicates that a high power LED in a packaging body can be cooled by immersion in a low boiling point liquid. By use of a phase transition during boiling of the liquid, significant amounts of heat can be removed.

While prior art cooling structures serve the intended purpose, they sometimes introduce piping requirements, forced flow requirements, or phase change situations. The cooling structures use copious amounts of metal and are bulky.

An object of the invention was to devise a heat dissipating mounting structure for high power semiconductor light sources that does not add obtrusive structures, specifically piping or fluid handling constraints, is simple in operation and is light weight.

### SUMMARY

The above objective has been met with a heat sink for a semiconductor light source, such as an LED array, that, in one embodiment, uses two spaced apart metal surfaces that first capture and distribute heat from the source, then radiate the heat away from both surfaces after convective heat transfer from the first metal surface to the second by a fluid contained between the surfaces.

A base, such as a circuit board supports an array of light sources and is in thermal communication with a first metal surface. A thin circuit board substrate, on which semiconductor light sources are mounted, in contact with the base, provides such thermal communication. The first metal surface captures heat from the base and distributes the heat over the metal surface by good thermal conductivity. The second metal surface is slightly spaced apart from the first metal surface with a liquid having good heat conductivity between the two surfaces. The liquid transfers heat from the first metal surface to the second and both surfaces radiate heat away.

In one embodiment, the metal surfaces are curved with one metal surface nested in the other, with the liquid occupying a separation space between the two surfaces. The two metal surfaces may be cup-shaped, i.e., circularly symmetric, with one cup-shaped metal surface within the other. A slight separation space between the two surfaces is occupied by a liquid with heat transfer characteristics comparable to water or anti-freeze solution. The inner cup-shaped surface can be shiny and serve as a reflector for LEDs in an array on a base mounted in the container side of the cup-shaped surface or in a second embodiment, on the opposite side (outer side) of the outer cup-shaped surface. In the first embodiment, the outer cup-shaped surface serves as a heat radiator surface after receiving heat by convective self-circulation of heated fluid.

The temperature gradient between the inside cup-shaped surface and the outer cup-shaped surface causes convective circulation of the fluid trapped between the two surfaces. Heat is transferred to the outer cup-shaped surface by the liquid at a temperature that may be close to boiling temperature and is radiated away to the ambient environment. The two surfaces are securely joined together so that the liquid is kept under pressure and does not boil, or only slightly without much vaporization. Heat is also radiated by the inner cup-shaped surface. In the second embodiment, there is a temperature gradient between the hotter outer surface and the cooler inner surface. Once again, the temperature gradient causes convective circulation between the two metal surfaces, tending to equalize temperature between the two, with radiation of heat into the ambient environment by both surfaces.

### BRIEF DESCRIPTION OF DRAWINGS

FIG. 1 is a side sectional view of a heat sink for a semiconductor light source in accordance with an embodiment of the present invention.

FIG. 2 is a top perspective view of the apparatus of FIG. 1.

FIG. 3 is a top perspective view of an alternate embodiment of the apparatus of FIG. 1 in an unassembled state.

FIG. 4 is a top perspective view of the apparatus of FIG. 3 in an assembled state.

FIG. 5 is an inside perspective view of the apparatus of FIG. 3 in an assembled state.

FIG. 6 is a side sectional view of another embodiment of a heat sink for a semiconductor light source in accordance with the present invention.

### DETAILED DESCRIPTION

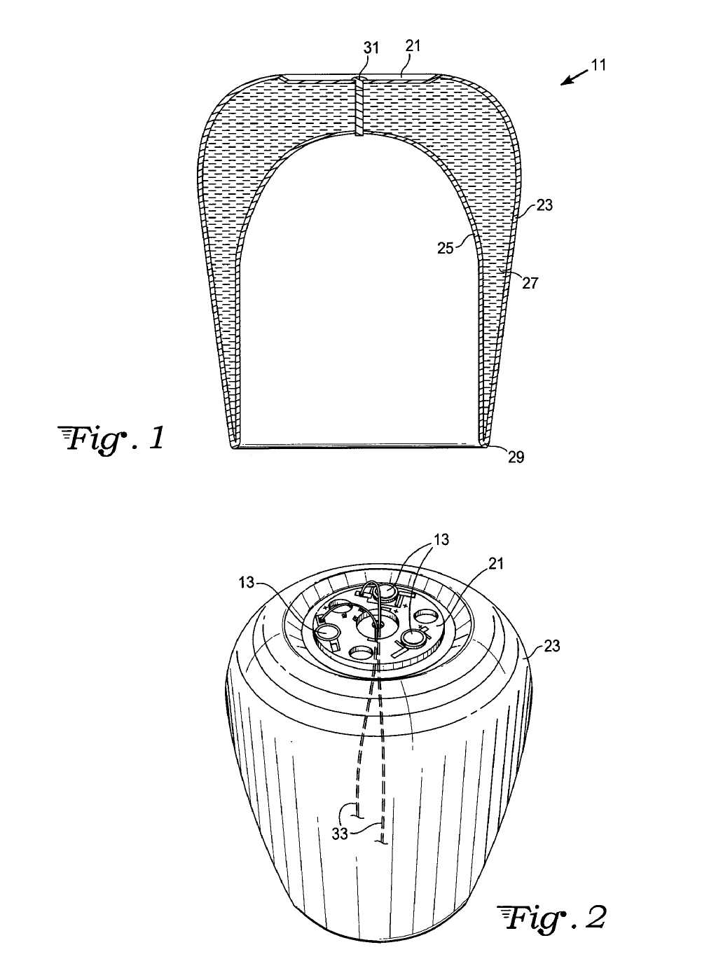

With reference to FIG. 1, a heat sink 11 forms a mounting structure for an array of semiconductor light sources, such as LEDs. A first metal surface 23 has an indentation that serves to receive base 21 that supports semiconductor light sources, typically mounted on a substrate that forms base 21. In the embodiment of FIG. 1 attachment is by means of rivet 31 which penetrates base 21 the first metal surface 23 and extends to a second metal surface 25 where the rivet is anchored. The second metal surface 25 is spaced apart from the first metal 23 by a liquid 27 filling the space between the first and the second metal surfaces. A circumferential seal 29 joins the first and second metal surfaces configured as nearly congruent shells, at an outer peripheral region so that the liquid 27 is trapped and cannot escape. Similarly, rivet 31 which joins the first and second metal surfaces, 23 and 25 respectively, is inserted in a manner so that there is no leakage of the liquid. The circumferential seal 29 may be formed by metal brazing. It should be noted that the inner and outer surfaces are cup-shaped, but this is merely an exemplary embodiment that is simple to fabricate. The first and second metal surfaces have good thermal conductivity and may be aluminum or steel or the like.

The liquid which fills the space between the first and metal surfaces is a liquid that has good heat transfer characteristics. The liquid should have a volume to mostly fill the space between the surfaces at operating temperatures. Small amounts of the liquid may change phase at operating temperatures but should not develop explosive pressures. Space for thermal expansion and for potential phase change vaporization should be left between the first and second metal surfaces. A partial vacuum environment may be helpful.

In FIG. 2, base 21 is seen atop the first metal surface 23 with semiconductor light sources 13 directing light upwardly, i.e., away from the first metal surface. Electrical wires 33 bring electrical energy to the light sources through a pop rivet and form an electrical circuit with an external power supply, not shown.

In operation, the base 21 transfers heat to the first metal surface 23 which tends to distribute the heat over the surface, including an inner surface where heat is transferred by conduction to liquid 27. Because there is a temperature difference the first metal surface and the second metal surface, convection is established within the liquid with convective flow of the liquid transferring heat between the first and second metal surfaces. Both the first and second metal surfaces radiate heat to the ambient environment, such as an air environment.

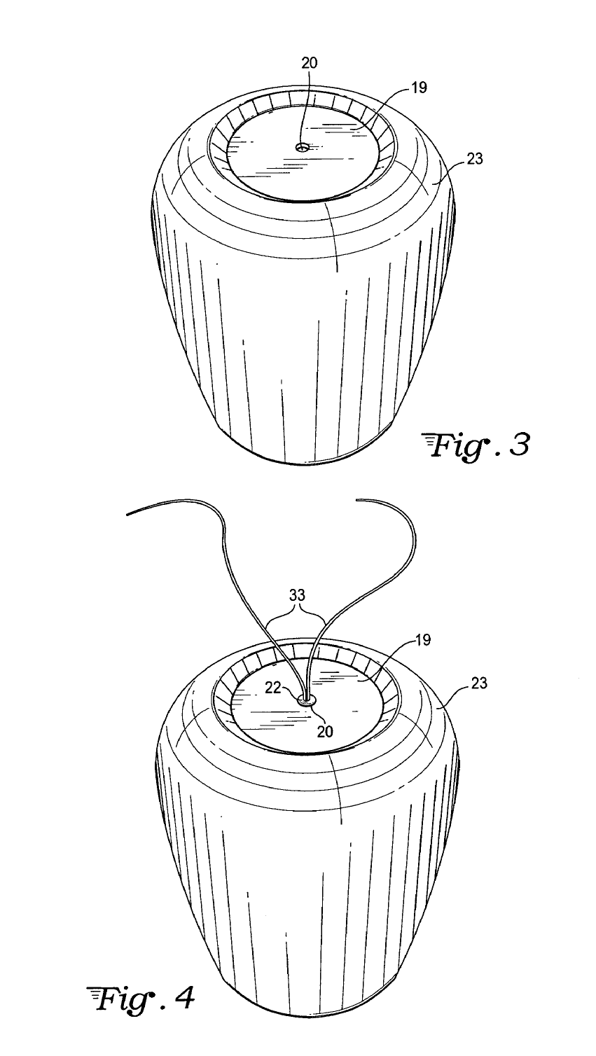

In FIG. 3, the first metal surface 23 is a shell seen to have a depression 19 without the presence of a base for mounting semiconductor light sources. Hole 20 in depression 19 extends through both the first and the second metal surfaces in an aligned manner. FIG. 4 shows electrical wires 33 passing into hole 20 in metal surface 23 and sealed with a grommet 22.

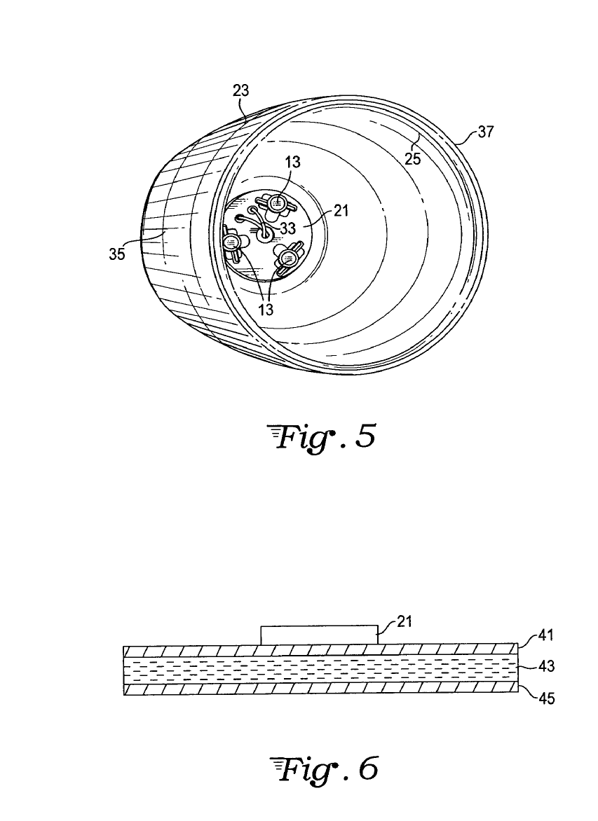

In FIG. 5, base 21 is seen mounted within the second metal surface 25 which is cup-shaped. The interior surface of the second metal surface is shiny and acts as a reflector for light sources 13. Electrical wires 33 are seen passing into the interior volume of the second metal surface 25 and are mounted to contacts on base 21 which may be a thin metal clad circuit board. The base 21 should be mounted to the second metal surface 25 in a manner so that there is good heat transfer between the semiconductor light sources and the second metal surface. In this embodiment, the semiconductor light sources transfer heat to the second metal surface 25 which, in turn, transfers heat to the liquid between the second metal surface and the first metal surface 23 by convection. Water is a preferred heat transfer liquid. The liquid capacity between the first and second metal surfaces must be sufficient to prevent much vaporization of the water and to allow adequate heat transfer. Ideally, the mounting structure operates as a black body radiator, radiating away as much heat as being transferred to the metal surface in contact with the base for the semiconductor light sources. Radiation occurs both from the first metal surface and the second metal surface. The inner and outer metal surfaces may be cup-shaped shells with the second metal surface nested within the first metal surface with a liquid volume between the two adequate to transfer heat from one metal surface to the other.

In the configuration of FIG. 5, the second metal surface may act as a reflector. If the second metal surface has a shape with approaches a parabolic shape, and the light sources are placed near the focus of the parabolic shape, a beam will emerge from the second metal surface. This beam may have a spotlight or directional shape and be useful for decorative or theatrical purposes or for a traffic light, or the like. For a theatrical spotlight, mounting handles 35 and 37 may be applied to the sides of the first metal surface 23 for ease of rotation of the light. The embodiment of FIG. 5 is useful for theater light because semiconductor light sources of various colors may be mounted on base 21, or alternatively may have the same color. By using semiconductor light sources of different colors, illumination of various beam colors may be obtained without the use of gel filters. For a traffic light, LEDs of the same color can be mounted in an array that is cooled by the mounting structure.

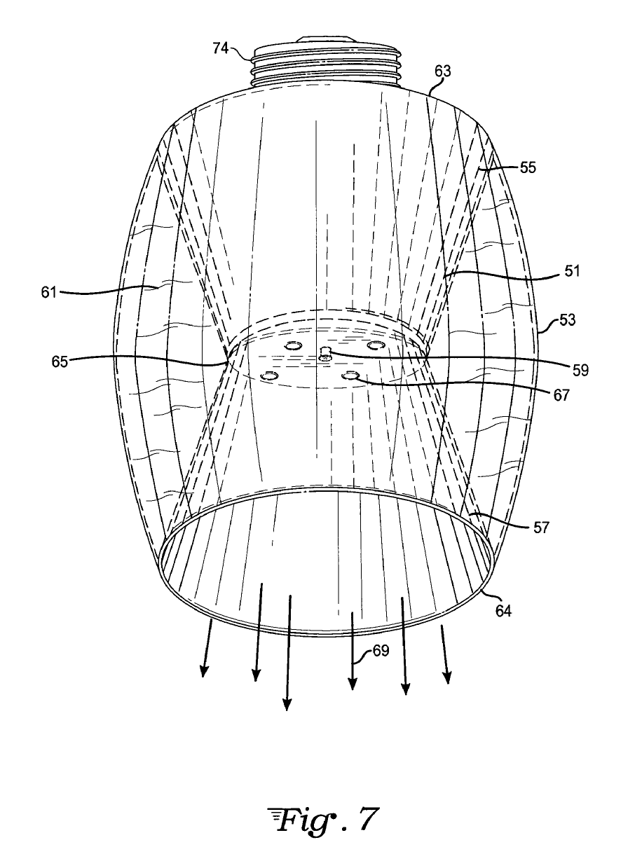

A generalized version of the invention is seen in FIG. 6 where base 21 having semiconductor light sources is mounted on a first metal surface 41 which is spaced apart from a second metal surface 45 by a heat transfer liquid 43 which is confined between the two metal surfaces. In this embodiment, the metal surfaces 41 and 45 are not cup-shaped, but are shown to be planar. Base 21 directs light away from both metal surfaces, but uses both to achieve cooling. The semiconductor light sources could be either LEDs, diode lasers, or combinations of LEDs and diode lasers.

With reference to FIG. 7, an upper cup 55 is connected to a lower cup 57 by a rivet or short axial tube 59. Lower cup 57 is made of metal and is contoured as a reflector structure for light source 67 mounted on base 65 all on the inside of the lower cup. Upper cup 55 may optionally also be made of metal and may have screw threads 74 for a conventional light socket. In that situation a transformer and rectifier combination would occupy the upper cup. Alternating current is sent into the upper cup via the screw threads and a AC or DC output voltage is carried by a lead wire through an axial rivet or tube to the light source 67. Alternatively, power may be supplied from an external supply by a wire bus not using a conventional screw base. Base 65 is heat conductive material that absorbs heat from light sources 57. Heat may be optionally transmitted upwardly to the upper cup 55. Surrounding the lower cup is a second metal surface 53 which is radially outward from the rivet axis and is joined to the first and second cups at upper rim 63 and lower rim 64. Between the first metal surface 51 and the second metal surface 53 is a liquid 61 which has good heat conductivity comparable to water or to anti-freeze (ethylene glycol). Heat from the light sources 67 is transferred to lower cup 57 through base 65. Heat from the lower cup 57 may be distributed to the upper cup 55 through the axial rivet 59 and then heat from the entire first metal surface is transferred by convection through liquid 61 to the second metal surface 53 where the heat is radiated. The lower cup 57 may be shaped as a beam forming reflector structure so that a light emerges from the lower cup 57 as a beam 69.

What is claimed is:

1. Heat sink packaging structure for an array of semiconductor light sources comprising:
a base supporting a semiconductor light source array;
first and second spaced apart metal surfaces, the first surface in thermal communication with the base and conducting heat away from the base, with the second metal surface configured as a thermal radiator with thermal radiation directed away from the first metal surface; and
a liquid having good heat conductivity and located in convective heat transfer relation between the first and second metal surfaces, whereby heat is distributed from the base to the first metal surface and then by convection to the second metal surface for radiative dissipation.

2. The apparatus of claim 1 wherein the first and second spaced apart metal surfaces are curved metal shells.

3. The apparatus of claim 3 wherein one of the first and second spaced apart metal surfaces is a circularly symmetric light reflector member.

4. The apparatus of claim 2 wherein the second metal shell surrounds the first metal shell in a nesting relationship.

5. The apparatus of claim 4 wherein the second metal shell is joined to the first metal shell in a manner maintaining said liquid therebetween under partial vacuum conditions whereby said liquid may approach its boiling point.

6. The apparatus of claim 3 wherein the reflector member has a focal area with said light source mounted at the focal area.

7. The apparatus of claim 6 wherein the second metal shell has screw threads for mounting in a light bulb socket.

8. Heat sink packaging structure for an array of semiconductor light sources comprising:
a base supporting an array of semiconductor light sources;
first and second spaced apart, axially symmetric thermally conductive metal surfaces with a liquid having good heat conductivity located between the first and second metal surfaces, the first metal surface being radially inward of the second metal surface and the base being radially lesser than the first metal surface, the first metal surface being in thermal communication with the base;
whereby heat is distributed from the base to the first metal surface and from the first metal surface to the second metal surface through said liquid so that heat can be radiated away by the second metal surface.

9. The apparatus of claim 8 wherein the first metal surface comprises first and second metal cups each having side walls and a bottom, the metal cups arranged with bottoms spaced apart and connected by an axial member, the first metal cup containing said base and second metal cup containing a power lead in electrical communication with the base through the axial member.

10. The apparatus of claim 9 wherein the second metal cup is shaped as a reflector for said array of semiconductor light sources with a reflective surface facing said light sources.

11. Heat sink packaging structure for an array of semiconductor light sources comprising:
a first metal surface contoured as a beam forming reflector surface for an array of semiconductor light sources mounted in thermal contact with the first metal surface; and
a second metal surface spaced apart from the first metal surface in a non-interfering relation with the beam forming reflector surface, the space between the first and second metal surfaces mostly occupied by a liquid having good heat conductivity and located between the first and second metal surfaces.
